(19) United States
(12) Patent Application Publication
(10) Pub. No.: US 2023/0087899 A1
(43) Pub. Date: Mar. 23, 2023

(54) Flex adapter for stripping tool

(71) Applicant: Aliaxis Deutschland GmbH, Mannheim (DE)

(72) Inventors: Martin Hager, Mannheim (DE); Pero Mikulic, Mannheim (DE)

(21) Appl. No.: 17/802,309

(22) PCT Filed: Mar. 10, 2021
(86) PCT No.: PCT/EP2021/056077

§ 371 Date: Aug. 25, 2022

(30) Foreign Application Priority Data
Mar. 10, 2020 (LU) 101679

(51) Int. Cl. B23B 5/16; B23B 5/12; B26D 3/16

(52) U.S. Cl. CPC B23B 5/162; B23B 5/12; B26D 3/164; B26D 3/166; B23B 2260/136

(57) ABSTRACT

A flex adapter for a stripping tool for treating plastic pipes or pipes coated with plastic, comprising a base body, at least two fins with respective sops. The fins are flexibly designed such that an outer radial load on the stops produces an opposing spring force; the fins are present in the rear region of the base body. The flex adapter according to the invention further comprises tensioning elements that are arranged integrally in the front region on the base body.

### CROSS-RELATION TO OTHER APPLICATIONS

This application claims the priority of and benefit to Luxembourg Patent Application No. LU 101679 filed on 10 Mar. 2020. The content of the Luxembourg Patent Application No. LU 101679 is hereby incorporated by reference in its entirety.

### FIELD OF THE INVENTION

The invention relates to a flex adapter for a stripping tool for treating plastic pipes or pipes coated with plastic with a barrier layer or oxide layer, preferably for welding or adhering two such pipes to one another, or for welding or adhering pipes with plastic fittings, sleeves, etc., for circumferential strip removal of the barrier layer or oxide layer on the outer surface of the plastic pipe before the welding treat, perpendicular or substantially perpendicular to its longitudinal axis, and a stripping tool of the aforementioned category, comprising the flex adapter.

### BACKGROUND TO THE INVENTION

Many stripping tools for treating plastic pipes are known, which have the form of a clamping mandrel, for example. DE 10 2007 046 631 A1 describes a stripping tool with a clamping mandrel which can be screwed onto the end of a threaded spindle at an end facing away from the housing. The clamping mandrel has the form of a pipe section provided with an internal thread into which the threaded spindle can be screwed, taking along with it the housing upon being rotated. With this pipe-shaped clamping mandrel, therefore, only plastic pipes with a certain interior diameter can be stripped.

DE 10 2009 010 776 A1 discloses a mechanism for adjusting the clamping claws. This allows the spacing of the clamping claws and therefore an adjustment settable to different pipe diameters through spacing intervals provided for such purpose that preferably correspond to a standardized diameter gradation scheme of pipes. This mechanism makes it possible to treat plastic pipes with interior diameters conforming to different standards.

The known clamping mandrels or clamping claws are designed for standardized dimensions of plastic pipes and therefore do not take into account the various wall thickness differences of standardized diameters of plastic pipes. For example, with a standardized extenor diameter of d25, the wall thicknesses can comprise 2.3 to 3 mm.

From document DE 10 2009 030 362 A1, a clamping mandrel for use in a stripping tool is known. The clamping mandrel comprises a pipe-shaped base body with a first end and a second end, wherein a passage is formed in the base body that at the first end is designed as a threaded bore for a threaded spindle and at the second end, as a smooth bore, which has a larger clear passage diameter than the threaded bore.

The German utility model DE 295 16 513 U1 teach es a cutting/stripping tool for manual cutting open or cutting into or stripping a pipe, preferably a plastic pipe.

The Japanese document JP H05 104301 A discloses an apparatus in which a tapered thread is arranged in a core and said core is screwed with force into the end section of a plastic pipe. A thread the cross-section of which is provided in the form of ratchet teeth, is engraved into a shaft that is arranged above the core and claw-shaped teeth on the core-side are engaged in the thread. Due to this, the shaft is moved forward by rotation and can be pulled out when pulled back. A bracket arranged above the shaft is fastened by screws of the cap nut between a joint and a union nut. A rotor is detachably fastened to the bracket and a blade holder is arranged axially on the rotor and is agitated forward and downward by a spring.

Furthermore, the Japanese document JP H06 79501 A teach es a cutting tool with which the exterior surface of a pipe can be cut as a scraper for cutting and removing oxide films on the surface of a treated pipe. A stripping blade is mounted on a support body such that it can move freely within a certain range in the radial direction of a treated pipe and a control guide section controls the cutting depth through its cutting.

The Japanese document JP 2010 179430 A discloses a scraper for cutting the exterior circumferential surface of a synthetic resin pipe. The scraper comprises a scraper body, a chuck arranged at a front part of the scraper body. Furthermore, a pipe receiver element is disclosed which is held by a claw of the chuck, a threaded shaft screwed together with a threaded hole of the scraper body, an arm arranged on the shaft in the rear part of the scraper body and a blade arranged on the arm. In order to prevent cut waste from ending up behind the scraper body, a projection is formed on the pipe receiver element that projects radially outward.

The invention seeks to solve the problem of providing a clamping mandrel or clamping claw for stripping tools of the aforementioned category, which is/are adaptable for different wall thicknesses of standardized pipe diameters by means of a simple design.

### SUMMARY OF THE INVENTION

This problem is solved by using a flex adapter equipped with fins or lamellae, and thus with accommodated suspension, that compensates for the wall thickness differences for standardized pipe diameters.

The flex adapter comprises a base body, at least two fins or lamellae, each with at least one stop and/or support bar. Said at least two fins are flexibly designed such that an outer radial load on the at least one stop creates an opposing spring force. The at least two fins are present in a rear region of the base body. Furthermore, the flex adapter according to the invention comprises a plurality of tensioning elements that are arranged integrally or in one piece at the front region of the base body. Through the presence of at least two fins, which can, in one example; be arranged substantially opposite from one another, an advantageous tolerance compensation and/or improved adaptability result.

In another aspect, at least three fins, preferably between three and six fins, are provided. This enables a more even distribution of an outer load.

In another aspect, the fins are radially distributed at an identical angle over the circumference of a rear region of the base body. This enables a more even distribution of an outer load over the circumference.

In another aspect, at least one, in particular, each one of the at least two fins form a closed spring element and provides a radial spring deflection in the dimension of the respective wall thickness, variably prescribed by the standard, of the corresponding pipe dimension. This allows the flex adapter to be inserted into the differing wall thicknesses of a standardized pipe.

In another aspect, at least one, preferably each one of the at least two fins, has an axial dimension that lies in the range from 2 mm to 40 mm, preferably 2 mm to 20 mm, preferably 2 mm to 10 mm.

In another aspect, at least one, preferably each one of the at least two fins, has higher deformability in the radial direction than deformability in other directions. Consequently, the fins of the flex adapter are more rigid in the axial direction and more flexible in the radial direction. An undesired deforming in an undetermined direction is therefore prevented.

In another aspect, at least one, preferably each one of the at least two fins, has a different flexibility than one of the plurality of tensioning elements. A difference in the flexibility of tensioning elements and fins favors a targeted application of the flex adapter for pipes of different standards.

In another aspect, the flex adapter further comprises, per each fin or stop, a holder element that is arranged integrally with the stop. The holder element serves as an axial limit when inserting the flex adapter into the pipe.

In another aspect, the deformability of at least one, preferably each one of the at least two fins, also allows the stop to be arranged at an angle relative to the longitudinal axis of the flex adapter. This makes it possible to use the flex adapter also for tapered pipes.

The aforementioned problem is further solved insofar as the previously described flex adapter is used with a stripping tool of the category indicated at the outset.

### DESCRIPTION OF THE DRAWINGS

FIG. 1 shows a perspective view of a first embodiment of a flex adapter.

FIG. 2 shows a first perspective view of a second embodiment of a flex adapter.

FIG. 3 shows a second perspective view of the flex adapter according to the sec-ond embodiment.

FIG. 4 shows the structure of a known prior art stripping tool.

### DETAILED DESCRIPTION OF THE INVENTION

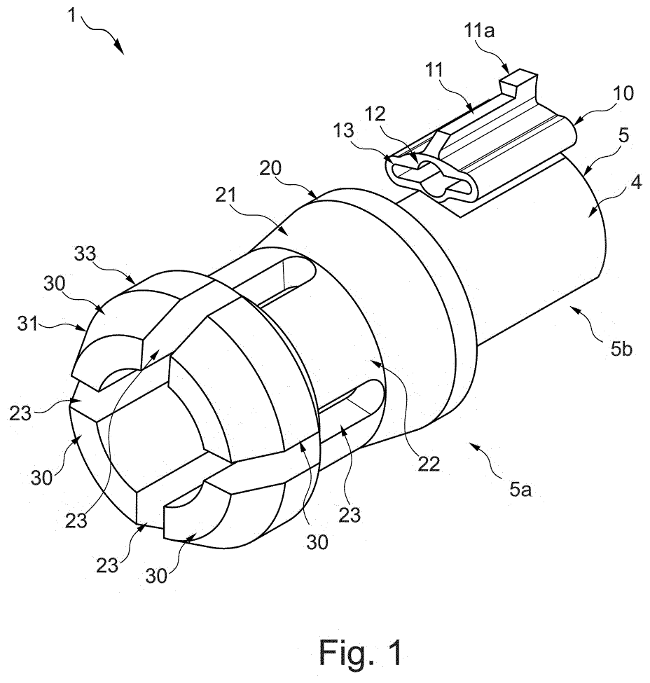

The individual components of a flex adapter according to a first and a second embodiment are explained in more detail with reference to FIGS. 1, 2 and 3.

A flex adapter 1 for a stripping tool 2 for treating plastic pipes or pipes coated with plastic consists of a base body 5 which has a rear region 5b with a first diameter 4 and a front region 5a with a second diameter 20, wherein the first diameter 4 is smaller than the second diameter 20 and the second diameter 20 has a first bevel 21.

In the rear region 5b, at least two (first embodiment) or three (second embodiment) fins 10 and/or lamellae 10 are distributed radially at the same angle over the circumference of the base body 5. The number of fins 10 is at least two, preferably, however, three; more preferably between three and six. In the depiction from FIG. 1, merely one of the two fins 10 can be seen, the second is substantially arranged on the opposite side and therefore not visible in the figure.

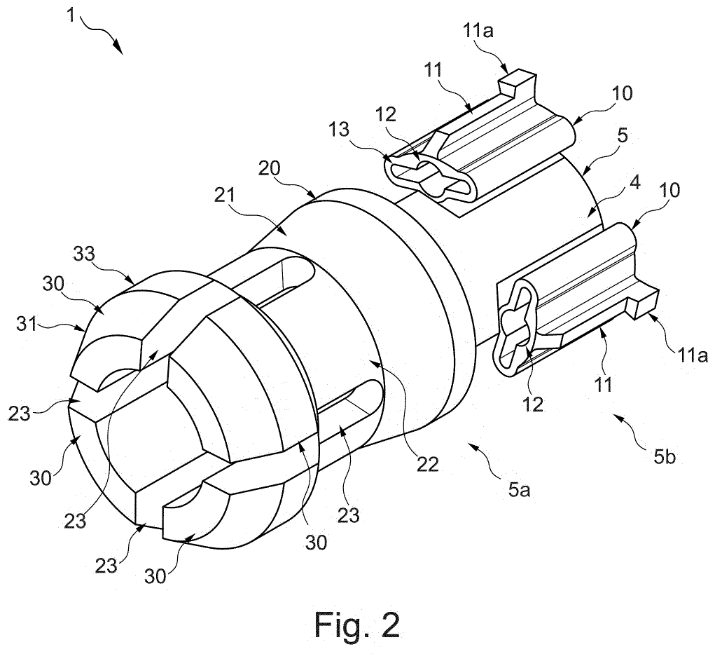

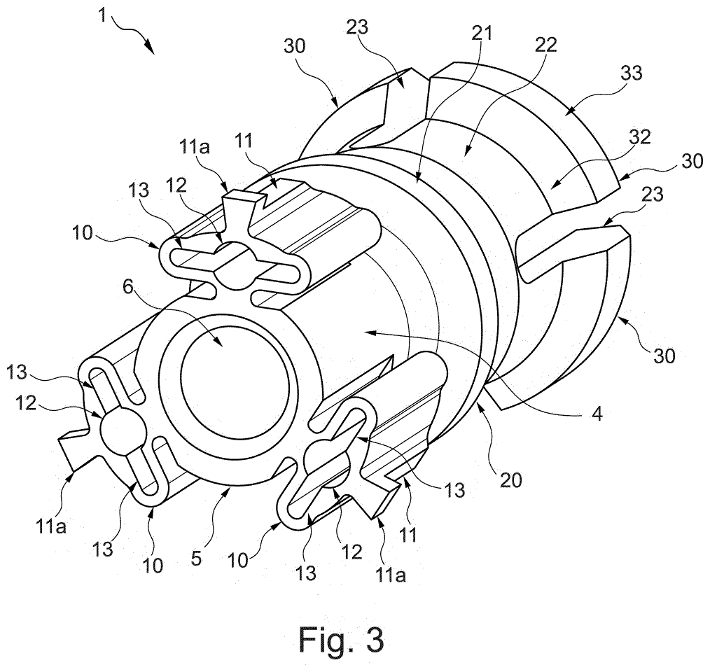

In FIGS. 2 and 3, showing a second embodiment, three fins 10 are provided, wherein in FIG. 2 merely two fins are visible, the third being concealed by the flex adapter in this depiction, although clearly visible in the depiction in FIG. 3.

The fin(s) 10 shown in the figures comprise a first flexibility structure 12 and a second flexibility structure 13 in the axial direction. In the radial direction, one holder element 11a with stop 11 and/or support bar 11 is arranged integrally on each fin 10.

The first flexibility structure 12 has a substantially circular base area that extends through the fin 10 in its longitudinal direction, or axial direction, thereby forming a recess. The second flexibility structure 13 has a substantially rectangular base area, wherein the shorter sides are rounded. The second flexibility structure 13 extends in the longitudinal or axial direction of the fin 10 and thereby also intersects the first flexibility structure 12, resulting in a recess.

The fin 10 is thus a closed spring element with a recess that results from the first flexibility structure 12 and the second flexibility structure 13. In this regard, the fin 10 has a higher deformability in the radial direction than deformability in other directions.

One skilled in the art is given the discretion to change the form of the first flexibility structure 12 and of the second flexibility structure 13 such that a desired and/or wanted rigidity of the fin 10 results. The fin 10 has an axial dimension that lies in the range 2 mm to 40 mm, preferably 2 mm to 20 mm, preferably 2 mm to 10 mm. A value of 2 mm is required due to the inner radius at the outlet. The inner regions of the cylindrical surface where the stripping tool is fixed or centered is usually 40 mm, which is why an appropriate dimension and also values obtained with an integer divider are particularly advantageous.

The stop 11 is arranged on the fin 10 integrally in radial extension with the fin 10. The stop 11 has a width that is less than the diameter of the circular base region of the first flexibility structure 12. The stop 11 is beveled on a front end of the fin 10 that is oriented in the direction of the front region 5a of the base body 5.

The holder element 11a is arranged on the stop 11 integrally in radial extension with the stop 11. The holder element 11a extends in the axial direction from the face of the rear region 5b of the base body 5 only a few millimeters along the stop 11.

One skilled in the art is given the discretion to change the shape and, above all, the dimensions of the holder element 11 a such that a desired and/or wanted radial outer surface of the holder element 11a results.

All or selected axial edges of the fin 10 are rounded, for better absorption of stress peaks due to external radial loads on the stops 11.

Due to the described features, the fins 10 present in the rear region 5b of the base body with respective stops 11 are flexibly structured such that an outer radial load on the stops 11 produces an opposing spring force. Consequently, the flex adapter 1 can be inserted into a plastic pipe or a pipe coated with plastic of a certain standardized dimension with a variable wall thickness region and remain therein due to the holding force resulting from the spring force and friction.

Due to the deformability of the fins 10, the fins 10 also enable a beveled arrangement of the stop 11 relative to the longitudinal axis of the flex adapter 1, whereby the flex adapter 1 can also be inserted into a tapered plastic pipe or a tapered pipe coated with plastic.

In both depicted embodiments, each fin 10 provides a radial spring deflection to the extent of at least the respective variable wall thickness of the corresponding pipe dimension specified by the standard. Although not shown, the respective fins could also be designed with individual differences.

The front region 5a of the base body 5 has a second diameter 20. This second diameter 20 has a first bevel 21 that extends from the second diameter 20 to a third diameter 22 of tensioning elements 30.

The tensioning elements 30 extend in the axial direction away from the front region 5a of the base body 5 and have a fourth diameter 33 that is arranged between a second bevel 31 and a third bevel 32.

The fourth diameter 33 is the same size as or larger than the first diameter 21.

In particular, the flex adapter 1 has two or preferably three to six tensioning elements 30 that are spaced relative to one another by recesses 23 and are more flexibly movable in the radial direction the farther they extend away from the front region 5a of the base body 5. In particularly preferred embodiments, the number and positioning of the fins and of the tensioning elements can be executed corresponding to one another, oriented with respect to one another or phase-shifted.

The flex adapter 1 further comprises an inner thread 6 that extends through the front region 5a and rear region 5b of the base body 5. With the inner thread 6, the flex adapter 1 can be screwed onto a threaded spindle of a stripping tool 2 with the help of a rotation handle after the flex adapter 1 has been inserted into a plastic pipe. The inner thread 6 is beveled on the face of the rear region 5b of the base body 5.

So that the tensioning elements 3 can be flexible in the radial direction, the flex adapter 1 comprises a smooth bore hole that extends from the inner thread 6 inside and along the tensioning elements.

The tensioning elements 30 have a different flexibility than the fins 10.

The flex adapter 1 is inserted, with the tensioning elements 30 leading, into an open end of a plastic pipe or a pipe coated with plastic. The inner edge of the open end of the pipe is first to contact the second bevel 31 of the tensioning elements 30, which has the effect that the tensioning elements 30 that are flexible in the radial direction taper radially. The fourth diameter 33 of the tensioning elements 30 presses on the inner surface of the pipe as the flex adapter 1 is further inserted into the pipe, pre-centering the tensioning elements 30 within the pipe. The inner edge of the open end of the pipe then contacts the third bevel 21 and the second diameter 20, which center the front region of the flex adapter 1 within the pipe, and therefore the flex adapter 1 itself. Through further insertion of the flex adapter 1 into the pipe, the inner edge of the open end of the pipe comes into contact with the front bevel of the stop 11 on the fins 10, whereby the fins 10, which are flexible in the radial direction, are pressed in the radial direction relative to the longitudinal axis. Due to their shape, the fins 10 generate a spring force counteracting the load, which depends on the wall thickness of the pipe and which centers and secures the flex adapter 1 inside the pipe. The flex adapter 1 is pushed into the pipe until the face of the pipe contacts the front faces of the holder elements 11a.

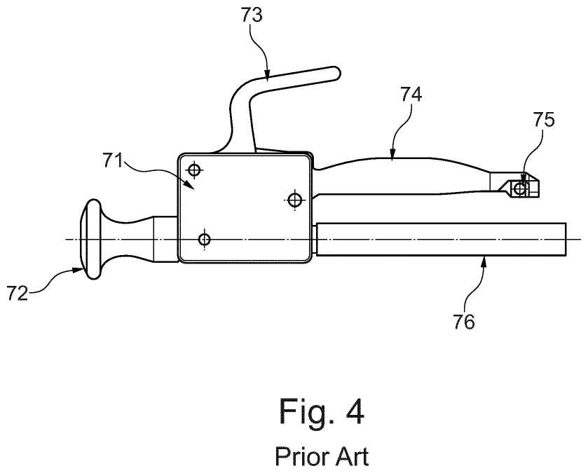

FIG. 4 shows a known stripping tool 2 for treating plastic pipes or pipes coated with plastic that are coated with a barrier layer or oxide layer, preferably for welding or adhering two such pipes to one another or pipes with plastic fittings, sleeves, etc. for circumferential-removal of the barrier layer or oxide layer on the outer surface of the plastic pipe before the welding procedure perpendicular or substantially perpendicular to its longitudinal axis. The known stripping tool 2 substantially comprises a housing 71, a rotation handle 72, an offset lever 73, a slider 74, a stripping blade 75 and a threaded spindle 76.

The flex adapter 1 is screwed onto the threaded spindle 76 at the end facing away from the housing 71 by rotating the threaded spindle 76 using the rotation handle 72 after the flex adapter 1 has been inserted into a plastic pipe. By rotating the threaded spindle 76 and therefore by screwing on the flex adapter 1, the end of the plastic pipe or pipe coated with plastic that is to be peeled arrives in the treating region of the stripping blade 75 at the end of the slider 74.

The lever 73 is used to lower the slider 74 and therefore the stripping blade 75 onto the end of the pipe to be stripped. Upon rotation of the rotation handle 72, the housing 71 rotates along with the threaded spindle 76, which screws forward into the flex adapter 1 that sits fixedly in the end of the pipe. The length of the slider 74 determines the depth of the surface of the pipe to be stripped.

Even though in the previously described embodiments the respective fins are shaped identically, this being also preferably simple in terms of production, this is not absolutely necessary. For example, one or more fins could be left out of the depicted holder element 11 a without impairing the overall functionality.

### REFERENCE NUMERALS

1 flex adapter

2 stripping tool

4 first diameter

5 base body

5a front region

5b rear region

6 inner thread

10 fin(s)/lamella(e)

11 stop/support bar

11a holder element

12 first flexibility structure

13 second flexibility structure

20 second diameter

21 first bevel

22 third diameter

23 recesses

30 tensioning elements

31 second bevel

32 third bevel

33 fourth diameter

1. A flex adapter for a stripping tool for treating plastic pipes or pipes coated with plastic, comprising:
a base body
at least two fins, arranged along the outer contour of the base body;
at least one respective stop arranged radially outside on the at least two fins; and
a plurality of tensioning elements, that are arranged integrally on a front region of the base body.

2. The flex adapter according to claim 1, comprising at least three, preferably three to six fins.

3. The flex adapter according to claim 1, in which the fins are distributed radially at an identical angle over the circumference of a rear region of the base body.

4. The flex adapter according to any one of the preceding claim 1, in which each of the at least two fins forms a closed spring element and provides a radial spring deflection path in the extent of the respective variable wall thickness of the corresponding pipe dimension prescribed by the standard.

5. The flex adapter according to claim 1, in which at least one, preferably each of the at least two fins, has an axial dimension in the range from 2 mm to 40 mm, preferably von 2 mm to 20 mm, preferably from 2 mm to 10 mm.

6. The flex adapter according to claim 1, in which at least one, preferably each of the at least two fins, has a deformability in the radial direction that is higher than a deformability in other directions.

7. The flex adapter according to claim 1, in which at least one, preferably each one of the at least two fins, has a different flexibility than one of a plurality of tensioning elements.

8. The flex adapter according to claim 1, further comprising a respective holder element integrally arranged with the stop.

9. The flex adapter according to claims 1, in which a deformability of at least one, preferably of each of the fins, also enables a diagonal arrangement of the stop relative to the longitudinal axis of the flex adapter.

10. A stripping tool for treating plastic pipes or pipes coated with plastic that are coated with a barrier layer or oxide layer, preferably for welding or adhering two such pipes to one another. or of pipes with plastic fittings, sleeves, or similar, for circumferential removal of a strip of the barrier layer or oxide layer on the outer surface of the plastic pipe before the welding procedure perpendicular, or preferably in particular perpendicular, relative to the longitudinal axis of the stripping tool comprising a flex adapter according to claim 1.
